(19) United States
(12) Patent Application Publication
(10) Pub. No.: US 2011/0217405 A1
(43) Pub. Date: Sep. 8, 2011

(54) METHOD AND INSTALLATION FOR PRODUCING A NON-WOVEN WEB WITH DUST REMOVAL

(76) Inventor: Jean-Michel Dubus, Nantes en Rattier (FR)

(21) Appl. No.: 12/998,070

(22) PCT Filed: Aug. 28, 2009
(86) PCT No.: PCT/FR2009/001041

§ 371 Date: May 23, 2011

(30) Foreign Application Priority Data
Sep. 16, 2008 (FR) 0805058

(51) Int. Cl. B29C 47/26

(52) U.S. Cl. 425/72.2

(57) ABSTRACT

The invention relates to equipment for producing a non-woven web, comprising a device (107, 108) for driving a filament packet, using an air stream, towards a conveyor (101) and an electrostatic device (117) arranged so as to apply electrostatic forces to the filaments of the driven packet, characterised by a means (801, 804) for removing dust from the driving air stream.

The present invention relates to methods and installations for producing non-woven webs. It is used more particularly in methods and installations for producing spunbond non-woven webs with a continuous slotted drawing device but also for closed systems, systems having cylindrical drawing devices and in general any device for producing a web using the application of electrostatic forces to a bundle of filaments carried by a current of air before depositing that bundle in the form of a web on a conveyor.

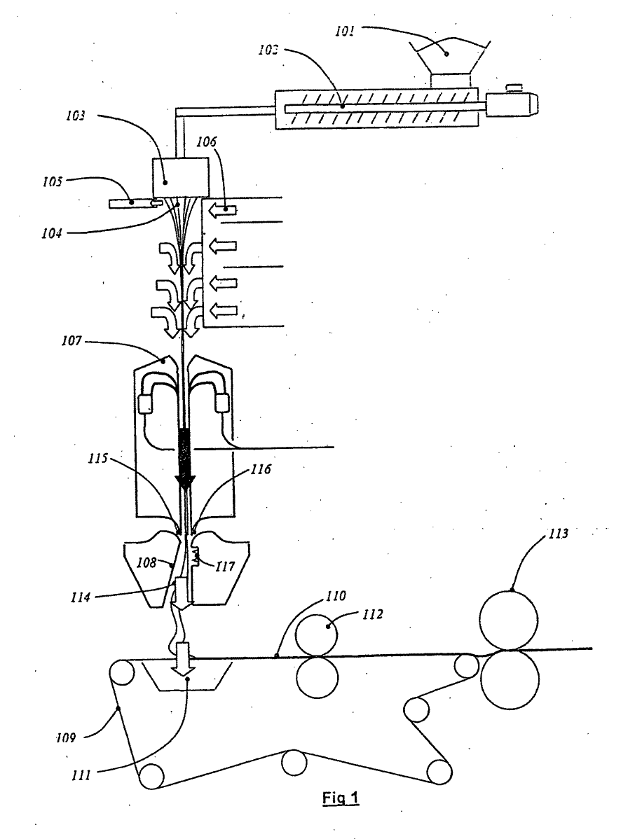

In the method for producing non-woven webs by spunbond technology, as set out succinctly in FIG. 1, the polymer in the form of granules (101) is molten in an extruder (102) then drawn through a die (103) in the form of continuous hot filaments (104). The fumes emitted during the drawing are collected by an acquisition device (105). The filaments are then cooled in a device (106) by a current of air at a controlled temperature and speed, then introduced into a drawing device (107). That device allows a tension force to be applied to the filaments which allows the molecular chains to be orientated and the desired diameter to be obtained.

At the outlet of the drawing device, an additional device called a forming device (108) is generally provided to allow the filaments to be deposited on a conveyor belt (109) in order to form the non-woven sheet (110). The main function of that forming device is to reduce the speed of the filaments, to disperse the bundles of filaments over the width of the machine in a manner which is as uniform as possible and to allow random and homogeneous deposit on the conveyor. The device (106), the device (107) and the device (108) form a device for moving the filaments downwards by means of a current of air.

An intake device (111) located below the web of the conveyor allows the sheet to be pressed and maintained on the conveyor. The non-woven sheet subsequently passes through a compacting device (112) and a consolidation device (113). The consolidation device (113) may be a calendering system or any other consolidation device (mechanical needling, chemical bonding, bonding by fluid jet). The sheet is conveyed towards the remaining steps of the method (processing, winding).

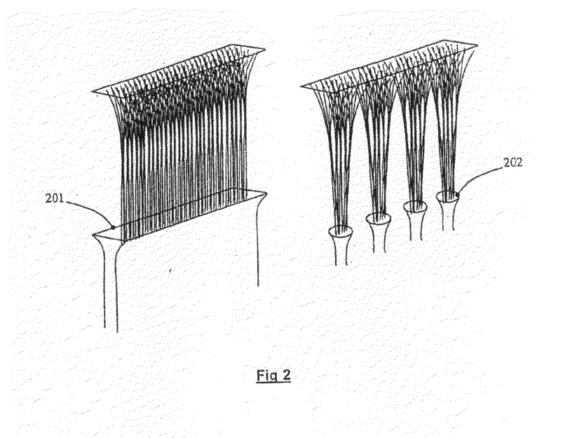

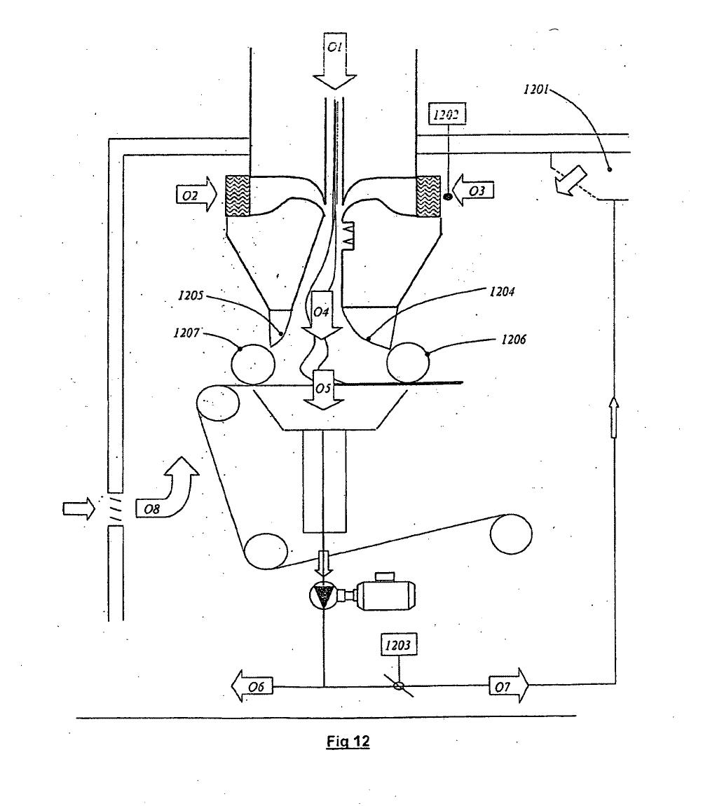

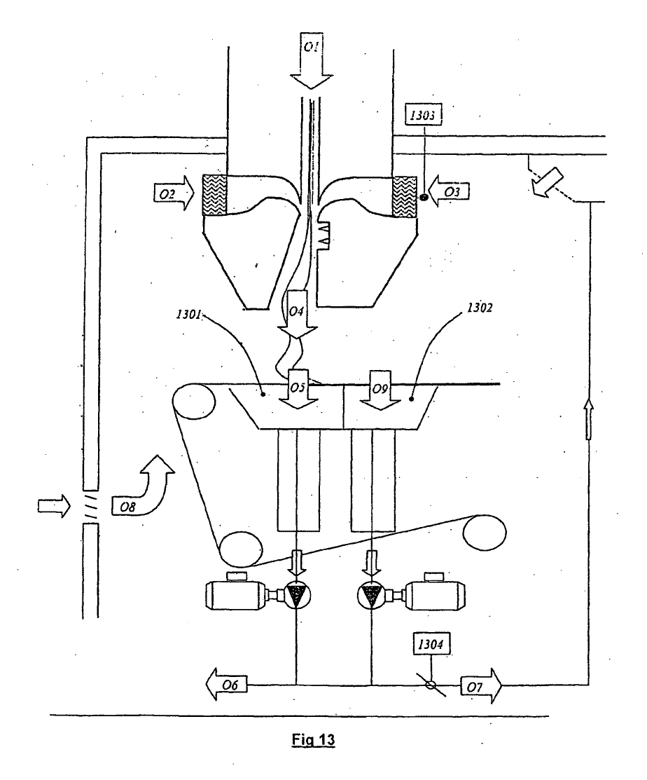

The drawing device, which is installed vertically, may be constituted (FIG. 2) either by a continuous aperture (FIGS. 2-201), in which the curtain of filaments is introduced, or a juxtaposition of cylindrical holes (FIGS. 2-202) which each receive a group of filaments.

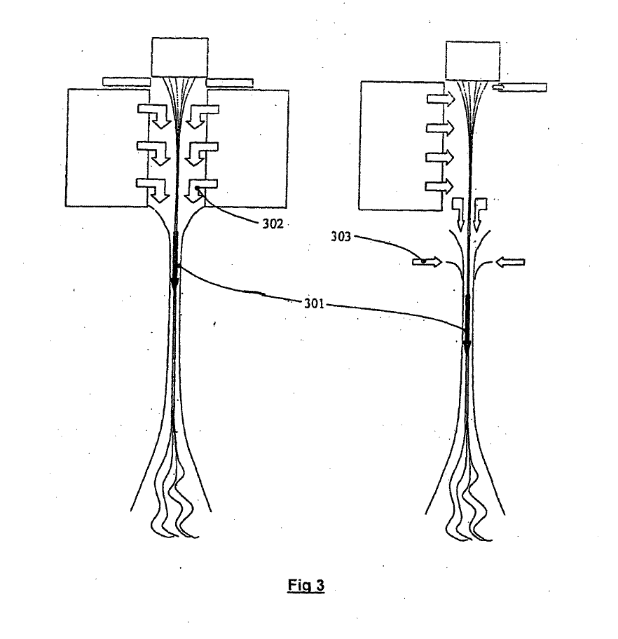

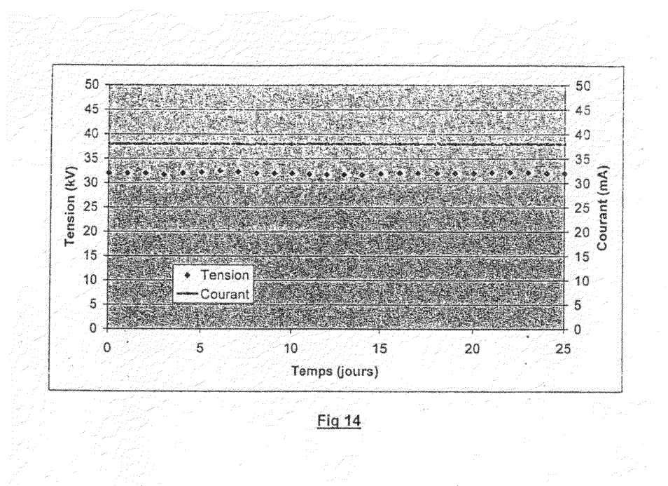

The effect of drawing is generally obtained (FIG. 3) by a current of air (FIGS. 3-301) which flows in a downward direction and which carries the filaments by friction with the air. The current of air may be generated either by the flow of air (FIGS. 3-302) introduced for cooling the filaments (closed system) or by additional air being introduced (FIGS. 3-303) into the drawing device, which brings about a general flow owing to the Venturi effect (open system).

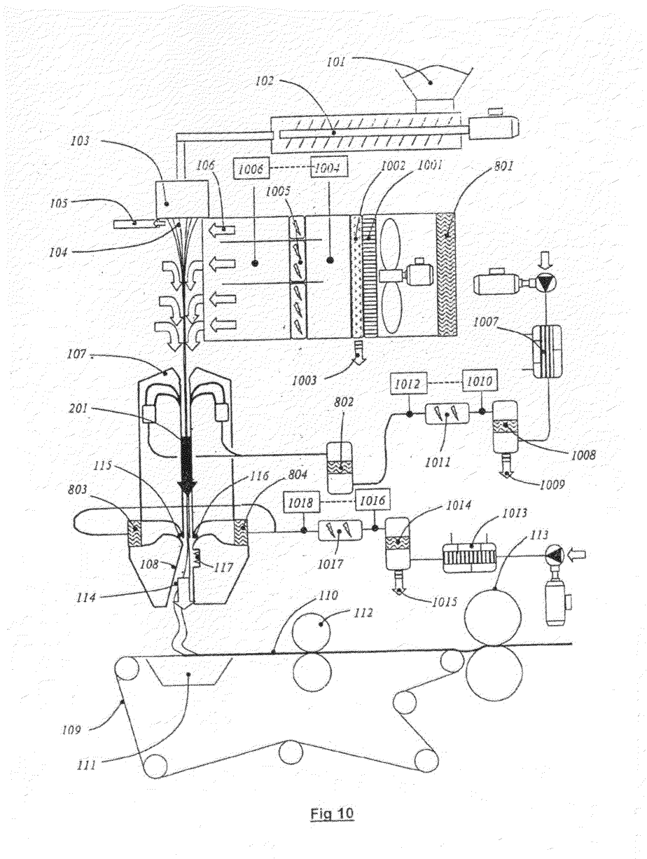

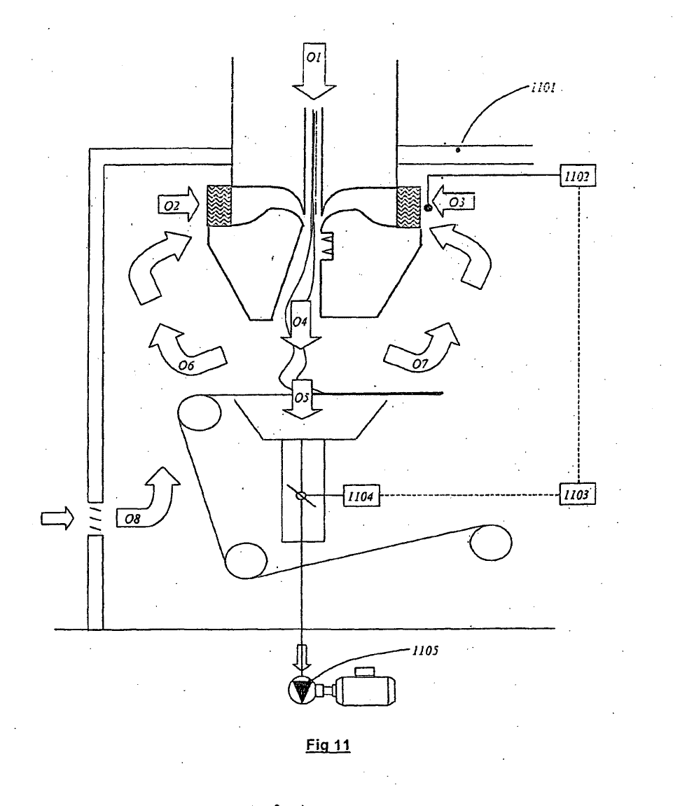

At the outlet of the drawing device, the forming system generally comprises an aeraulic system (for example a diffuser, FIGS. 1-114) which modifies the flow profile of the air at the outlet of the drawing device. It is particularly advantageous to provide in a judicious manner additional apertures for introducing air (FIGS. 1-115 and FIGS. 1-116) which allow control of the flows and prevention of the appearance or untimely development of turbulence.

A device of the electrostatic type (FIGS. 1-117) may judiciously complement the effectiveness of the diffuser with regard to the ungrouping of the filament bundles.

The electrostatic device operates on the principle of the Corona effect which brings about ionisation of the air near a point subjected to electrical potential.

The Corona effect requires:
a small electrode which may be either a point contact (or a point type network) or a wire,
an electrical field which is produced by the difference in potential established between the electrode and an opposite electrode which generally comprises a conductive planar plate which is located opposite the main electrode.

The small size of the electrode brings about a concentration of the field lines which can exceed the ionisation threshold and bring about ionisation of the air.

Depending on the polarity applied, the Corona effect is said to be positive or negative and results in different ionisation of the air (FIG. 4).

In both cases, particles having positive and negative polarity are produced and are then carried by the electrical field towards the electrode or the planar plate having opposite polarity. During their movement, those particles collide with other particles present in the volume and may recombine and cancel out their charge or create new charges. Thus, during those collisions, the filaments will also receive electrostatic charges and be subjected in turn to the electrostatic forces created by the electrical field. All the filaments which are not charged identically will not be subjected to identical forces and movements and will thereby be dispersed in the space between the electrode and the planar plate.

On the other hand, the filaments are preferably charged with the same polarity. The material constituting the filament is naturally electropositive or electronegative and therefore has a tendency more readily to accept charges of the polarity corresponding to its electrostatic affinity. Owing to that charge, the filaments will have a tendency to repel each other and thereby to occupy the volume of air available in a more uniform manner.

The important parameters of the device are the voltage applied between the electrodes (generally several tens of kilovolts, from 10 to 70 kilovolts) and the current which is produced (by movement of the ions) between those same elements (several tens of milliamps per metre of length, from 2 to 20 mA per metre of length).

The voltage applied directly influences the force applied to a charged particle. A particle having a charge Q is subjected to a force F=Q×E, E being the electrical field which is directly proportional to the electrical voltage.

The current obtained is reflects the quantity of the charges which move between the electrodes. Thus, an increase in the current indicates an increase in the quantity of charges present in the volume between the electrodes and consequently an increase in the probability of depositing charges on the filaments and modifying their trajectory.

The major advantage of this electrostatic device is that it allows dispersal of the groupings of filaments which are generated by the equipment located upstream. Those groupings generally result from occurrences of turbulence or local instances of heterogeneity of the air flows, which it is difficult or impossible to completely dispense with.

By inducing an electrical charge in the filaments, the electrostatic device brings about their relative movement in space either by the electrical field created by the electrostatic device itself or by repulsion with the adjacent filaments which have the same polarity.

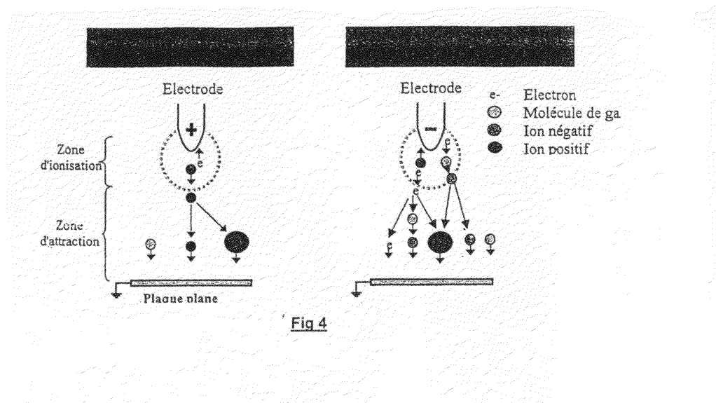

FIG. 5 shows two examples of trajectories followed by the filaments when there is no electrostatic device (FIG. 5.1) and when there is one (FIG. 5.2).

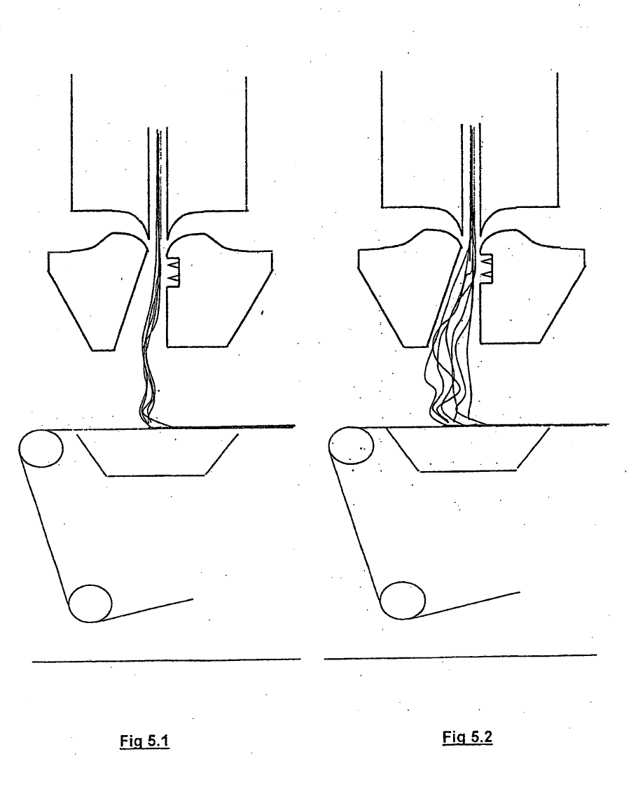

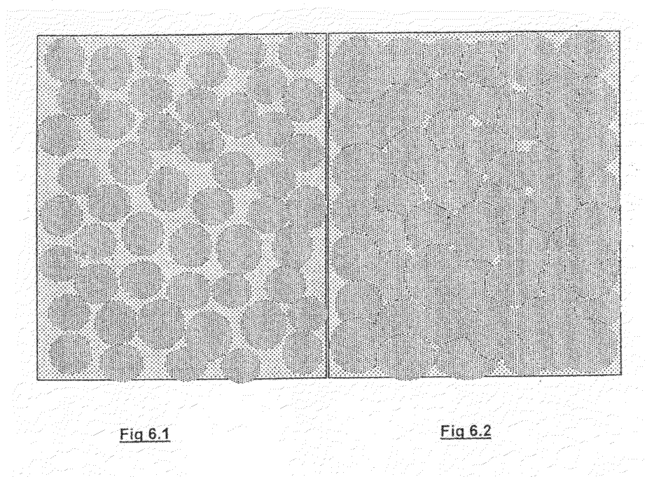

That effect on the filaments allows the appearance of the non-woven web to be greatly modified, as shown in FIG. 6.

As indicated in FIG. 6.1 (FIG. 6.1), without any electrostatic device the web generally has a cloudy appearance which comprises zones containing a large number of filaments which are substantially interleaved and zones containing a much smaller number of filaments. All the physical properties of the web (such as the basis weight, behaviour under a traction load, permeability to a gas, a liquid or a powder) are affected by that heterogeneity.

When there is an electrostatic device, the zones containing more filaments are much more diffuse, their size increases, they overlap each other (FIG. 6.2). Consequently, the web gains uniformity and all the physical properties sought by users are improved.

However, it is found that, within a few hours, the device for producing a non-woven web no longer provides a satisfactory web such as the one in FIG. 6.2, but instead provides a web such as the one in FIG. 6.1.

The invention overcomes this disadvantage and allows a web having good properties to be obtained for a long operating time.

The invention relates to a spunbond tower successively comprising, in a downward direction:
a die providing hot filaments,
a device for cooling the hot filaments to form cooled filaments by means of air which is introduced via a cooling air inlet,
a device for drawing the cooled filaments to form drawn filaments by means of air which is introduced via a drawing air inlet and
a forming device for depositing drawn filaments in the form of a web on a conveyor belt, the forming device comprising two opposing air inlet apertures at the same level, each aperture extending over the entire transverse extent of the forming device and an electrostatic device below the level of the apertures, characterised by means for removing dust from the air being introduced via the apertures.

The Corona effect explained above in a very simplified manner is in fact an extremely complex physical phenomenon. The molecules and ions created in that reaction are very greatly dependent on the polarity and the composition and the nature of the gas present in the space between the electrode and the planar plate.

Thus, solid particles or chemical molecules present in the gas will be able, in the same manner as the filaments, to receive an electrostatic charge and be subjected to the effects of the electrostatic forces. Those particles will be subjected to a horizontal movement either towards the electrode or towards the planar plate and will ultimately be able to become deposited on those elements, causing contamination of the device.

The confirmed effect of that contamination is a reduction in the Corona effect which brings about a reduction in the current having constant voltage and which causes an increase in the voltage necessary to establish a given current.

This has two effects which disrupt the system:
the first is that, by reducing the current, the quantity of charges present in the space is reduced and therefore the probability of charging the filaments. This results in a reduction in the charges present on the filaments and consequently a reduction in the quantity of filaments which move;
the second is that, by increasing the voltage, the mean electrical field which exists between the electrode and the planar plate is increased. In that manner, with an equivalent charge, the filaments are subjected to a greater load and therefore to a greater magnitude of movement. During their movement, those filaments come into contact with the walls of the channel which has the effect of creating faults in the non-woven fabric.

Generally, during the use of the device, the effect of clogging is characterised by an increase in the voltage applied in order to maintain the current at the desired value then, when the maximum voltage available is reached, by a reduction in the current.

In parallel with this reduction in current, the appearance of the web changes progressively from the quasi-uniform appearance of FIG. 6.2 into the heterogeneous appearance of FIG. 6.1. Below a given value of current, the appearance becomes too cloudy and the product is no longer acceptable to the end user. The installation is stopped in order to allow the device to be cleaned. The criterion for judging whether to decide to shut down the installation in order to clean it is generally a minimum current level below which the non-woven fabric is considered to be non-compliant.

FIG. 7 shows a development line which is typical of an electrostatic charge device used under normal production conditions before the improvements according to the invention are put in place. The installation is adjusted to provide a current of approximately 38 milliamps under a voltage of 32 kilovolts. For 3 hours, the device operates in a stable manner, the voltage and the current are constant over time. After approximately 3 hours, there is observed an increase in the voltage necessary to keep the current at the desired value of 38 milliamps. That increase in voltage is linked to particles which create an insulating layer being deposited on the earth plate and on the electrodes. The voltage regularly increases until it reaches the maximum available at the high voltage source (40 kilovolts in the example selected). Once the maximum voltage has been reached, the development of the clogging of the device brings about a reduction in the current, which is weak at first, then progressively faster and faster. After 12 to 13 hours of production, the current available is less than 30 milliamps (that is, 80% of the initial value) and the effectiveness levels of the system are insufficient to ensure adequate production quality.

Preferably, there are provided means for removing dust from the air which is introduced via the cooling air inlet and via the drawing air inlet,
the means for removing dust from the air which is introduced via the apertures and/or via the cooling air inlet comprise a filter having a filtration threshold between 80% and 90% gravimetric,
the means for removing dust from the air which is introduced via the drawing air inlet comprise a cartridge type filter having a filtration threshold of from 0.01 to 10 micrometres upstream of a compressor.

According to a variant, the dust removal means comprise an intake below the conveyor drawing in the current of air into a recycling circuit which returns it to the drive device. Once the current of air has had its dust removed, it can be returned to the installation without it causing clogging. There is preferably provided a device for adjusting the flow of the intake. Recycling is improved if there is provided a confinement sleeve for the bundle of filaments extending from the bottom of the drive device to the conveyor. For the same reason, it is also possible to provide a chamber for supplying air to the drive device, the inlet of the chamber being provided with a dust filter.

The installation may comprise means for dehumidifying the current of air. The particles of water have the same detrimental effect as the dust. Those means may successively comprise, upstream of the drive device, an air/water heat exchanger, a droplet separator and a reheater. That type of separator, which is inexpensive, is sufficient to improve the service-life during which the installation operates correctly.

In the appended Figures, which are given purely by way of example:

FIG. 1 is a schematic illustration of a spunbond tower,

FIG. 2 is a perspective view of two different types of filament bundles,

FIG. 3 illustrates the drawing effect by means of two schematic illustrations,

FIG. 4 illustrates the Corona effect by means of two schematic illustrations,

FIG. 5.1 is a schematic illustration of the distribution of the filaments when there is no electrostatic device, whilst there is one in FIG. 5.2,

FIGS. 6.1 and 6.2 are views of the non-woven fabric obtained in FIGS. 5.1 and 5.2, respectively,

FIG. 7 is a line giving the voltage and the current as a function of time of an electrostatic charge device when the spunbond tower does not have any dust removal means,

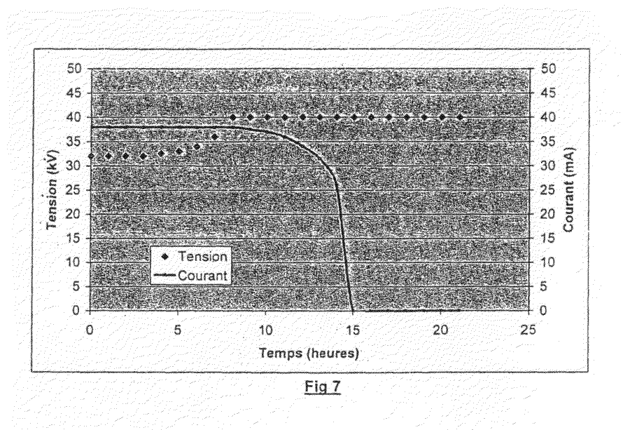

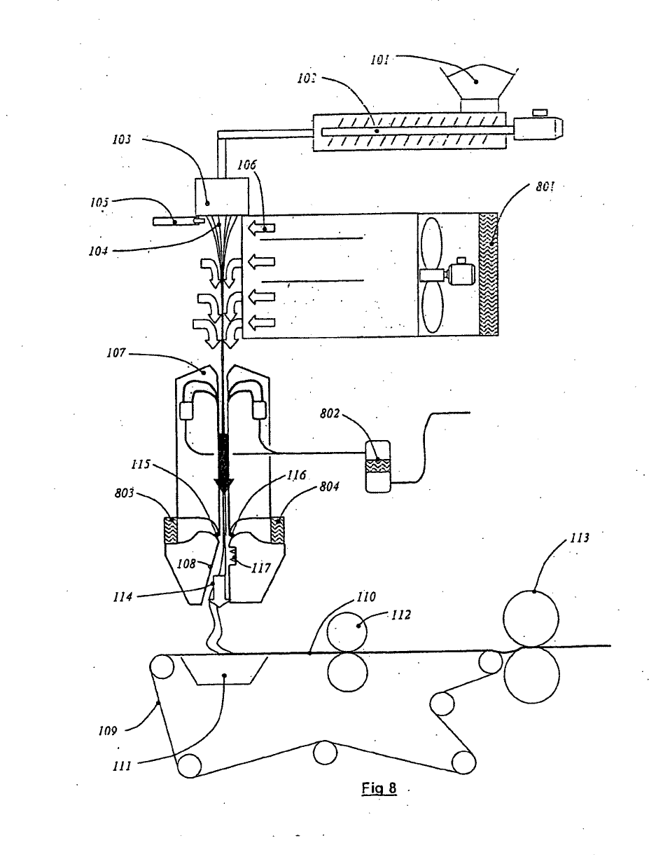

FIG. 8 is a schematic view of a spunbond tower according to the invention,

FIG. 9 is a graph showing the voltage and the current of the electrostatic system as a function of time of the spunbond tower of FIG. 8,

FIG. 10 is a variant of a spunbond tower according to the invention,

FIG. 11 is a variant of a spunbond tower according to the invention,

FIG. 12 is another variant of a spunbond tower according to the invention,

FIG. 13 is a variant of a spunbond tower according to the invention,

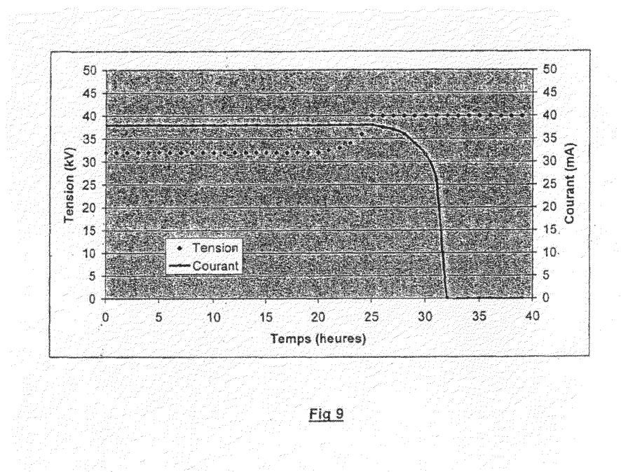

FIG. 14 is a graph showing the voltage and the current of the electrostatic device as a function of time of the spunbond tower of FIG. 13.

The spunbond tower of FIG. 8 comprises all the elements of the spunbond tower of FIG. 1 which will not therefore be described again and which are assigned the same reference numerals.

A first improvement to the tower involves providing adequate filtration systems which are provided as indicated in FIG. 8 upstream of all the air inlets in the forming system. Thus, this involves the following:
the air introduced into the drawing device with the filaments. Owing to the presence of the filaments, it is not possible to directly filter the air which is introduced into the drawing device. However, since a large proportion of the air being introduced into the drawing device is from the air for cooling the filaments, which is conveyed by friction with the filaments, it is advantageous to filter the air for cooling the filaments. This may be carried out as indicated in FIG. 8 by positioning removable filters (801) at the inlet of the sheath for conveying the air for the filaments. The filters used are preferably folded filters (allowing the filtration surface to be increased) which have a filtration threshold which is preferably between 80 and 90% gravimetric. The filters PRP3 with natural electrostatic action from the company Inter-filtre have been used with success.
The air introduced into the drawing device via the injection apertures. Since the device is supplied with pressurised air, the filtering device is preferably a cylindrical cartridge type filter which is positioned in the conveying pipe for the compressed air (FIG. 8 802) upstream of a compressor. A filtration threshold of from 0.01 micrometres to 10 micrometres is recommended for good efficiency of the device. The filtering cartridges of the N type (threshold=1μ) and S type (threshold=0.01μ) of Messrs. Chauméca Gohin have been successfully tested.
The air introduced into the drawing device or into the diffuser via the additional injection apertures. The filtering of this air can be carried out by positioning a supply chamber upstream of the introduction apertures. The inlet of this chamber is provided with an assembly of removable filters (FIG. 8 803 and 804). The filters used are preferably folded filters (allowing the filtering surface to be increased) which have a filtration threshold which is preferably between 80 and 90% gravimetric. The filters PRP3 with natural electrostatic action from the company Inter-filtre have been used with success.

It is important to note that the apertures which introduce air just above the electrostatic device are preponderant and must be handled with the greatest of care. The particles introduced via those apertures in the event of filtration malfunctions will pass in immediate proximity to the electrodes and will therefore be preferentially deposited thereon by the electrostatic effect.

The provision of those different filtering elements allows the service-life between two cleaning operations to be improved. FIG. 9 shows the typical behaviour of an electrostatic device identical to the one described in FIG. 7 but provided with filters at the air inlets.

In that manner, it is possible to establish that the behaviour begins to deteriorate only after approximately 20 hours of production instead of 3 hours when the air inlets are not filtered. Shutting down the installation for cleaning, necessary owing to unacceptable damage to the appearance of the web when the current drops below 30 mA, is reached after 30 hours of operation whereas, without the filters, shutdown was necessary after 13 hours, 30 minutes of operation.

One improvement to the invention involves providing a system which allows the relative humidity of the air in the installation also to be controlled.

Since the relative humidity of the air desired is generally less than the ambient conditions encountered in production plants, the solution adopted for achieving the relative humidity of the air required is to cool the air below the dew-point in order to condense the excess humidity, followed by reheating which allows the desired temperature to be reached again.

The relative humidity of air is the relationship expressed as a percentage of the partial pressure of water vapour contained in the air relative to the partial pressure of saturated vapour under identical temperature and pressure conditions. The relative humidity of the air can be measured using relative humidity sensors which directly convert the humidity level of the air into an electrical signal.

A device of the type indicated in FIG. 10 is provided in the air for cooling the filaments and comprises an air/water exchanger for cooling (1001), a droplet separator (1002) provided with a condensate outlet hole (1003). A temperature sensor (1004) located downstream of the droplet separator allows control and adjustment of the temperature at the outlet of the cooler, acting either on the water flow or on the temperature of the water in the cooler. By being cooled, the air is thus brought to the dew-point temperature desired for the method. The value sought is generally between 5° C. and 15° C. and preferably less than 10° C. The desire for lower values necessitates devices which require more energy and do not provide a sufficiently great improvement to justify the operating costs that are necessarily higher. Subsequently, a reheater (1005) allows air to be brought to the final temperature required, generally between 10° C. and 35° C., more usually in the range from 15° C. to 30° C. The power of the reheater is adjusted by means of a temperature/humidity sensor (1006) which is located downstream of the reheater. By the humidity being measured, the user can thereby control the relative humidity obtained. The device can also be improved by automatically controlling the temperature of the air at the outlet from the cooling operation in accordance with the relative humidity finally sought.

That dehumidification system can be provided in all the air inlets in the installation.

An identical device is thus provided in the injection air of the drawing device and comprises the cooler (1007), the droplet separator (1008) with a condensate outlet hole (1009) and the reheater (1011). The temperature at the outlet of the cooler is controlled by means of the temperature sensor (1010). The final temperature and humidity are controlled by means of the temperature and humidity sensor (1012). Dry air can be drawn in by the tower from a chamber (not illustrated) which extends round a portion of the tower.

Controlling the humidity of the air in the region of the injection apertures of the forming device is also important because the air introduced via those apertures passes near the electrodes. Air can be processed by a device which is identical to the preceding device, that is to say, cooling, elimination of the condensate and reheating. That device may optionally be avoided when the flow of air discharged by the intake device (FIG. 8 111) located below the web being formed only discharges a quantity of air corresponding to the air injected into the apertures of the drawing device and the air introduced at the inlet of the drawing device.

Thus, as illustrated in FIG. 11, the total flow leaving the forming device (Q4) comprises the flow carried by the drawing unit (Q1) supplemented by the flow carried by the injection apertures of the diffuser (Q2 and Q3). The proportion between the flows may vary in accordance with the geometry of the forming device and the apertures. In general, the flow Q1 carried by the drawing unit represents from 50% to 80% of the total flow Q4 leaving the forming device, the flow Q2+Q3 being injection via the introduction apertures of the forming system being between 20% and 50% of the flow Q4.

If the flow Q5 drawn in by the intake device located below the web of the conveyor is less than the flow Q4 being discharged from the forming device, a portion thereof is therefore delivered as two flows Q6 and Q7. When the assembly is provided inside a vessel (1101) which insulates the device from ambient air, the flows Q6 and Q7 are drawn in again at Q2 and Q3 in the region of the apertures of the diffuser. An opening formed in the insulating vessel allows the flow Q8 necessary for balancing the entirety of the flows to be introduced or delivered.

When the installation is in operation, the temperature injected in the region of the flows Q2 and Q3 progressively increases, bringing about a reduction in the relative humidity. After a few minutes of operation, the assembly becomes stabilised at the value sought.

A sensor (1102) located in the intake zone of the flows Q2 and Q3 allows measurement of the temperature and humidity values. It can be connected by means of an adjustment device (1103) to a motorised register (1104) which allows control of the flow drawn-in by the fan (1105).

Other variants of the balancing device of the flows can also be provided as indicated in FIGS. 12 and 13.

FIG. 12 shows a device comprising a network of sheaths (1201) which allow a portion of the air being discharged from the intake fan to be moved towards the insulating vessel. The flow Q5, which is drawn in by the fan and which is confined by a confinement sleeve (1204) of the bundle of filaments and which extends as far as two rollers (1206, 1207) providing the sealing with respect to the conveyor, is equal to the flow Q4 leaving the forming device. At the delivery of the fan, the flow Q5 is divided into a flow Q6 which is discharged outwards and a flow Q7 which is recirculated towards the insulating vessel. The flow Q7 is adjusted, for example, by means of a motorised register (1203). A sensor (1202) installed in the insulating vessel allows control of the temperature and humidity of the air. The register (1203) may optionally be automatically controlled by the measurement of temperature and humidity provided by the sensor (1202) by an automatic control system.

That device allows adjustment of the proportion of flow recirculated without modifying the quantity of air drawn in via the web of the conveyor. The web is often affected by other parameters of the method and the fact of varying that value in order to control the temperature and humidity in the insulating vessel, as indicated in FIG. 11, may cause the appearance of new faults in the non-woven web.

FIG. 13 shows a device comprising a double intake system below the conveyor. The first device (1301) which is called a formation chamber and which is located directly under the outlet of the diffuser acts directly during the formation of the non-woven web on the conveyor. The second intake device (1302) which is called the maintenance chamber is located downstream in accordance with the movement of the belt. It ensures good maintenance of the web during transport as far as the pressing roller or the consolidation device.

The two devices are adjustable independently of each other and may each comprise a system for recirculating air. In general, the air from the formation chamber (flow Q5) is completely discharged outwards so as to eliminate in an effective manner the gas products from the Corona effect. The air from the maintenance chamber (flow Q9) is recirculated partially or completely by means of the motorised register (1304) in order to obtain the temperature and humidity values required measured by the sensor (1303).

By means of the control combined with the cleanliness and relative humidity of the air which passes into the electrostatic device, by means of devices such as those described above, there is obtained behaviour of the electrostatic device as illustrated in FIG. 14, that is to say, complete stability over several days of operation.

1. Spunbond tower successively comprising, in a downward direction:
a die (103) providing hot filaments,
a device (106) for cooling the hot filaments to form cooled filaments by means of air which is introduced via a cooling air inlet,
a device (107) for drawing the cooled filaments to form drawn filaments by means of air which is introduced via a drawing air inlet and
a forming device (108) for depositing drawn filaments in the form of a web on a conveyor belt (109), the forming device comprising two opposing air inlet apertures (115, 116) at the same level, each aperture extending over the entire transverse extent of the forming device and an electrostatic device (117) below the level of the apertures,
characterised by
means (803, 804) for removing dust from the air being introduced via the apertures.

2. Spunbond tower according to claim 1, further comprising means for removing dust from the air which is introduced via the cooling air inlet and via the drawing air inlet.

3. Spunbond tower according to claim 1 wherein the means for removing dust from the air which is introduced via the apertures and/or via the cooling air inlet comprise a filter having a filtration threshold between 80% and 90% gravimetric.

4. Spunbond tower according to claim 2 wherein the means for removing dust from the air which is introduced via the drawing air inlet comprise a cartridge type filter having a filtration threshold of 0.01 to 10 micrometres upstream of a compressor.

5. Spunbond tower according to claim 3 wherein the dust removal means comprise an intake (111) below the conveyor drawing in the current of air into a recycling circuit which returns it to a chamber for supplying the apertures, the filters being positioned at the inlet of the chamber.

6. Spunbond tower according to claim 5, further comprising a device for adjusting the flow of the intake.

7. Spunbond tower according to claim 6, further comprising a confinement sleeve (1204) for the bundle of filaments extending from the bottom of the forming device to the conveyor.

8. Spunbond tower according to claim 1 further comprising by means for dehumidifying the current of air.

9. Spunbond tower according to claim 1 which comprises two intake devices below the conveyor, one directly below the forming device and the other downstream in the direction of movement of the conveyor.

10. Spunbond tower according to claim 2, wherein the means for removing dust from the air which is introduced via the cooling air inlet comprise a filter having a filtration threshold between 80% and 90% gravimetric.

11. Spunbond tower according to claim 4, wherein the dust removal means comprise an intake below the conveyor drawing in the current of air into a recycling circuit which returns it to a chamber for supplying the apertures, the filters being positioned at the inlet of the chamber.
